(19) United States
(12) Patent Application Publication
(10) Pub. No.: US 2007/0038633 A1
(43) Pub. Date: Feb. 15, 2007

(54) Method and system for executing procedures in mixed-initiative mode

(75) Inventors: Lawrence Bergman, Mt. Kisco, NY (US); Vittorio Castelli, Croton-on-Hudson, NY (US); Tessa A. Lau, New York, NY (US); Daniel A. Oblinger, Washington, DC (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/200,081

(22) Filed: Aug. 10, 2005

(51) Int. Cl. G06F 17/30

(52) U.S. Cl. 707/10

(57) ABSTRACT

A system for and method of executing mixed-initiative procedures to allow at least one of a user and a computer system to take initiative of the procedure from the other at any point of the procedure, in which the mixed-initiative procedure can include a computer-based procedure in which the user and the computer system cooperate during the execution to allow each other to take the initiative at any point of the procedure.

### CROSS-REFERENCE TO RELATED APPLICATIONS

This application is related to the following U.S. Patent Applications:

Ser. No. ______, entitled “ ” and filed on ______, (Disclosure No. YOR8-2003-0843US1); Ser. No. ______, entitled “______” and filed on ______ (Disclosure No. YOR8-2002-0579US1); and Ser. No. ______, entitled “ ” and filed on , (Disclosure No. YOR8-2002-0510US1); Ser. No. ______, entitled “ ” and filed on ______, (Disclosure No. YOR8-2003-0655US1); Ser. No. ______, entitled “SYSTEMS AND METHODS FOR GENERATING AND DISTRIBUTING EXECUTABLE PROCEDURES FOR TECHNICAL DESK-SIDE SUPPORT” and filed on ______, (Docket No. YOR9-2003-0056US1); AND Ser. No. ______, entitled “METHOD FOR INDUCING HIDDEN MARKOV MODEL WITH A SIMILARITY METRIC” and filed on ______, (Docket No. YOR9-2004-0289US1), each of which is assigned to the present assignee and is incorporated herein by reference, in its entirety.

### BACKGROUND OF THE INVENTION

1. Field of the Invention

The present invention generally relates to a method and system for executing a computer-based procedure where the user and the computer system cooperate during the execution to allow each other to take the initiative of the procedure at any point of the procedure, and more particularly, to a method and system for allowing “mixed” initiative in which the user can perform previously unseen and/or uncoded actions that are unrelated to the procedure being performed, or that are related to the procedure being performed but correspond to uncoded and/or previously unseen paths through the procedure.

2. Description of the Related Art

Consider for example a related art wizard that guides a user during the procedure of installing a program. At each point in time, the wizard proposes one or more possible actions for the user. For example, the installation wizard commonly asks the user to select the type of installation to be performed (e.g., minimal, typical, full, custom, etc.), to go back to the previous dialog, or to cancel the procedure. At this particular point in time, the user can do one of the three possible actions; namely those mandated by the wizard. Thus, in this example, the wizard has the initiative and the user cannot take it away from the wizard. That is, the user cannot skip the current step and continue from the following step, etc.

Further, the related art mixed-initiative systems are programmed. That is, the related art mixed-initiative systems are not constructed independent of models. Also, the related art mixed-initiative systems are capable only of performing on-track procedures. That is, they are capable of allowing the user to perform only predicted actions. The related art mixed-initiative systems also are not capable of suggesting multiple hypotheses.

Thus, the related art systems are too rigid and do not provide the desired flexibility.

### SUMMARY OF THE INVENTION

In view of the foregoing and other exemplary problems, drawbacks, and disadvantages of the conventional methods and structures, an exemplary feature of the present invention is to provide a method and system for executing a computer-based procedure where the user and the computer system cooperate during the execution to allow each other to take the initiative of the procedure at any point of the procedure, and more particularly, to a method and system for allowing “mixed” initiative in which the user can perform previously unseen and/or uncoded actions that are unrelated to the procedure being performed, or that are related to the procedure being performed but correspond to uncoded and/or previously unseen paths through the procedure.

In an illustrative, non-limiting aspect of the invention, a method of executing mixed-initiative procedures includes allowing a user and/or a computer system to take initiative of the procedure from the other of the user and the computer system at any point of the procedure. The mixed-initiative procedure preferably includes a computer-based procedure in which the user and the computer system cooperate during the execution to allow each other to take the initiative of the procedure at any point of the procedure.

In another illustrative, non-limiting aspect of the invention, a method of executing mixed-initiative procedures includes allowing a user and/or a program to take initiative of the procedure from the other of the user and the program at any point of the procedure. The user and the program preferably cooperate, and the program preferably includes a model of the computer-based procedure.

The method preferably includes allowing the user to take initiative from the program, observing user actions and responses of applications used to perform the procedure, aligning the observed user actions and application responses to the model of the procedure, and allowing the user to relinquish the initiative to the program.

In another exemplary aspect of the invention, the step of aligning the observed user actions and application responses to the model of the procedure preferably includes using multiple strategies to align the observed user actions and application responses to the model of the procedure, combining the alignments produced by the multiple strategies to produce a collection of alignments, scoring the alignments, and displaying to the user at least one alignment of the scored alignments which includes a highest score of the scored alignments.

In yet another exemplary aspect of the invention, the step of aligning the observed user actions and application responses to the model of the procedure, further includes using multiple strategies to modify the model of the procedure to be substantially consistent with the user actions and application responses, combining the results of the multiple strategies to produce a collection of modifications of the procedure, scoring the modifications in the collection of modifications, and displaying to the user at least one modification of the scored modification which includes a highest score of the scored modifications.

In another exemplary aspect of the invention, the step of allowing the user to relinquish the initiative to the program preferably includes continuing cooperation between the user and the program from a procedure step which follows a step aligned with the observed action in the alignment including the highest score.

In yet another exemplary aspect of the invention, the step of allowing the user to relinquish the initiative to the program preferably includes continuing cooperation between the user and the program from a procedure step which follows a step modified based on the observed action in the modification including the highest score.

In another exemplary aspect of the invention, the step of displaying preferably includes displaying to the user a plurality of alignments of the scored alignments, wherein the plurality of alignments are arranged based on a predetermined preferred procedural model, a quality of results, an order of the scored alignments, and/or a certainty of the alignments.

In yet another exemplary aspect of the invention, the step of displaying preferably includes displaying to the user a plurality of modifications of the scored modifications, wherein the plurality of modifications are arranged based on a predetermined preferred procedural model, a quality of results, an order of the scored modifications, and/or a certainty of the modifications.

In another exemplary aspect of the invention, the method includes allowing mixed-initiative procedures wherein the user can perform at least one of previously unseen actions and uncoded actions which are unrelated to the procedure being performed.

In yet another exemplary aspect of the invention, the method includes allowing mixed-initiative procedures wherein the user can perform at least one of previously unseen actions and uncoded actions which are related to the procedure being performed and correspond to at least one of uncoded paths and previously unseen paths through the procedure.

In another exemplary aspect of the invention, the method preferably includes identifying at least one of previously unseen actions and uncoded actions performed by a user, and flagging substantially unlikely actions performed by the user. The user preferably can perform the previously unseen actions and uncoded actions that are unrelated to the procedure being performed, and/or are related to the procedure being performed and correspond to at least one of uncoded paths and previously unseen paths through the procedure.

In another exemplary aspect of the invention, the method preferably includes detecting off-track actions performs by the user in the mixed-initiative procedure, constructing at least one realignment possibility based on the user's off-track action and a model of the mixed-initiative procedure, performing realignment based on at least one of the user's selection, a highest score of an alignment of the at least one realignment possibility.

In another exemplary aspect of the invention, the step of allowing preferably includes observing an action by the user, and comparing the action with previously observed actions and determining whether the action substantially corresponds to at least one of the previously observed actions. The previously observed actions preferably include a collection of user actions (e.g., a training set) used to construct a model of the procedure.

If the action is determined to substantially correspond to the at least one of the previously observed actions, the method preferably constructs a hypothesis for each of the at least one of the previously observed actions in the procedure model which is determined to substantially correspond to the action, and scores the hypothesis for each of the previously observed actions in the procedure model which are determined to substantially correspond to the action.

If the action is determined to correspond to an unobserved action, the method preferably retains at least one previously constructed hypothesis.

Another exemplary aspect of the invention is directed to a method of deploying computing infrastructure in which computer-readable code is integrated into a computing system, and combines with the computing system to perform the aforementioned exemplary methods.

Yet another exemplary aspect of the invention is directed to a signal-bearing medium (e.g., a recordable or computer readable signal-bearing medium) tangibly embodying a program of machine-readable instructions executable by a digital processing apparatus to perform the aforementioned exemplary methods.

In another exemplary aspect of the invention, a system for executing mixed-initiative procedures to allow a user and/or a computer system to take initiative of the procedure from the other of the user and the computer system at any point of the procedure, includes a detector that identifies previously unseen actions and/or uncoded actions performed by a user in the procedure.

The user preferably performs the previously unseen and/or the uncoded actions that are unrelated to the procedure being performed, and/or are related to the procedure being performed and correspond to the uncoded paths and/or the previously unseen paths through the procedure.

The exemplary aspects of the present invention can provide a flexible and adaptive method and system for executing mixed-initiative procedures, in which the user and the computer application (e.g., an assistant) can cooperate during the execution to allow each other to take the initiative of the procedure at any point of the procedure. Thus, the exemplary aspects of the present invention allow for mixed initiatives in which the user can perform previously unseen and/or uncoded actions that are unrelated to the procedure being performed, or that are related to the procedure being performed.

For example, the user can decide to take a shortcut through the procedure, and the computer application preferably would be able to follow along and continue assisting the user from the correct point in a procedure.

Another exemplary advantage is evident when an error condition occurs that is not explicitly accounted for by the procedure model. Here, after the user takes corrective actions, the computer application preferably is able to continue assisting and cooperating with the user.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates an exemplary high level method 100 according to the present invention;

FIG. 2 illustrates an exemplary method 200 according to the present invention;

FIG. 3 illustrates another exemplary method 300 according to the present invention;

FIG. 4 illustrates an exemplary method 400 for detecting whether the user's actions are on-track or off-track according to the present invention;

FIG. 5 illustrates an exemplary method 500 for constructing hypotheses for off-track mixed-initiatives according to the present invention;

FIG. 6 illustrates an exemplary method 600 for updating the hypothesis set according to the present invention;

FIG. 7 illustrates another exemplary method 700 for constructing hypotheses according to the present invention;

FIG. 8 illustrates an exemplary hardware/information handling system 800 for incorporating the present invention therein;

FIG. 9 illustrates a signal bearing medium 900 (e.g., storage medium) for storing steps of a program of a method according to the present invention; and

FIG. 10 illustrates an exemplary RAID array 1000 (e.g., storage medium) for storing steps of a program of a method according to the present invention.

### DETAILED DESCRIPTION OF EXEMPLARY EMBODIMENTS OF THE INVENTION

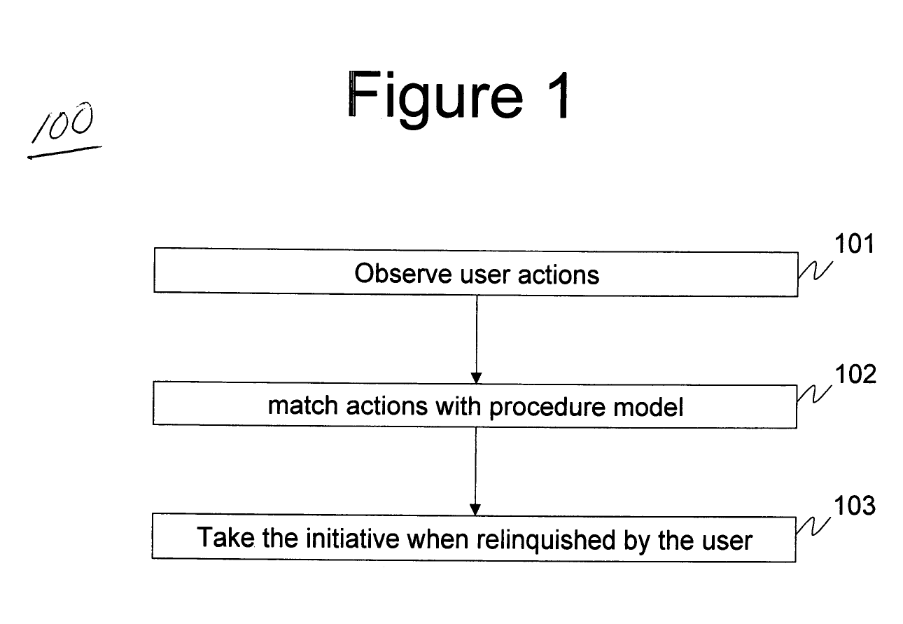

Referring now to the drawings, and more particularly to FIGS. 1-10, there are shown exemplary aspects of the method and structures according to the present invention.

The unique and unobvious features of the exemplary aspects of the present invention are directed to a novel system and method which allows the user and a computer system to cooperate during the execution of a procedure and further allows each to seamlessly take the initiative at any point in time of the procedure. Particularly, the novel system and method according to the exemplary aspects described below are capable of executing a computer-based procedure in which the user and the computer system cooperate during the execution to allow each other to take the initiative of the procedure at any point of the procedure, and more particularly, are capable of allowing mixed initiative in which the user can perform previously unseen and/or uncoded actions that are unrelated to the procedure being performed, or that are related to the procedure being performed but correspond to uncoded and/or previously unseen paths through the procedure.

### EXEMPLARY ASPECTS

Prior to discussing the exemplary aspects, some terminology will be defined for purposes of the present application.

Procedure refers to a structured task having a definable goal, and that can be automated to a point where the required user intervention or input is limited.

Model and procedure model are used interchangeably to denote an executable description of a procedure, namely, to an entity that can provide a human-readable description of the procedure and that can be automatically executed on behalf of or in cooperation with the user to accomplish the task of the procedure.

Actor denotes an entity that interacts with a system. For example, a user interacting with an application, a control program interacting with a robotic mechanical system, and an autonomic agent interacting with a network of computer systems are actors.

Action denotes the finest granularity of interaction between an actor and a system. Actions can be defined at different levels of abstraction (for example, the interaction between a user and a computer via a keyboard can be described in terms of typed strings, or of individual key presses). It will become apparent to one of ordinary skill in the art that the present invention can be equally applied to embodiments that differ in the level of abstraction at which actions are defined. Therefore, for purposes of the present application, no assumption is made as to any specific choice of action definition.

Procedure step is the atomic element of a procedure, namely, a portion of a procedure that describes an individual action.

Initiative, during the execution of a computer procedure, denotes the process of forcing the next step to be taken to belong to a well-specified, restricted set of at least one possible step.

Consider for example a wizard that guides the user during the procedure of installing a program. At each point in time, the wizard proposes one or more possible actions for the user: for example, the installation wizard commonly asks the user to select the type of installation to be performed (minimal, typical, full, custom), to go back to the previous dialog, or to cancel the procedure. At this particular point in time, the user can do one of three possible actions, namely those mandated by the wizard. The wizard has the initiative, and the user cannot take it away from the wizard, for example by skipping the current step and continuing from the following step.

Mixed Initiative denotes a mode of interaction between a computer application and a user in which the application and the user cooperate to perform a procedure in such a way that both user and system can take the initiative at each point in time. Note that a user selecting the type of installation, as described above, does not take the initiative away from the application, but rather performs a choice under the supervision of the application, that maintains the initiative.

Consider now, for example, a user and an application cooperating towards the execution of a procedure. This procedure can be executed on the application itself, or on one or more applications other than the one cooperating with the user. To distinguish between the application cooperating with the user and other applications involved in the procedure, we use the term “assistant application”, or more simply “assistant”, to denote the former.

As an illustrative, non-limiting example, assume that the procedure relates to troubleshooting of a network connection of a computer. In this exemplary case, the assistant application and the user can interact with multiple additional applications, including the operating system. The assistant application can have a model of the procedure to troubleshoot the network connection of a computer, including a collection of steps and the conditions governing how these steps are selected and executed in sequence.

When the assistant application has the initiative, it can provide the user with a graphical or textual model of the procedure and can indicate to the user the actions to be taken next (for example, how to run a diagnostic test program for the network card hardware). The assistant also can propose to perform a single step, a collection of steps, to perform the entire procedure on behalf of the user, etc.

While the user follows the directions of the assistant, the assistant has the initiative.

On the other hand, consider another exemplary case in which the user decides not to follow the directions of the assistant, and assume that the assistant allows the user (or users) to take actions other than those proposed by the assistant itself. As the user takes the initiative away from the assistant, the preferred behavior of the assistant in this exemplary aspect of the invention is to observe the actions of the user, match them to the model of the procedure, and ensure that it can retake the initiative of the procedure from the user, for example, whenever the assistant succeeds in identifying the part of the procedure being performed by the user.

Note that a user taking the initiative from the assistant could include performing one (or more) of the following exemplary activities (among others):
1. Executing a previously unseen path of the procedure.
In this case, the user performs action that are in the model of the procedure, but does not follow any order implied by said model.
2. Executing previously unseen actions pertaining to the procedure.
For example, the user troubleshooting the computer connectivity could be performing a diagnostic sub-procedure that is not part of the procedure model available to the application.
3. Responding to an unforeseen situation.
For example, the diagnostic test program mentioned above may not be installed on the user's computer, and the user would install it before running it; as another example, consider the case in which said diagnostic program unexpectedly “crashes”, forcing the user to repeat the test.
4. Performing incorrect actions.
The user could take the initiative and decide to perform certain actions that are part of the procedure but that should not be performed at the current point in time.
5. Executing an action (or actions) that is irrelevant to the procedure.
For example, the user could take the initiative and decide to execute an action (or actions), which is irrelevant to the procedure, such as reading e-mail, searching the web, etc.

Turning now to the Figures, FIG. 1 describes and illustrates an exemplary aspect of the present invention with respect to the behavior of the assistant while the user takes the initiative.

With reference to FIG. 1, in Step 101, the assistant observes the actions of the user. One of ordinary skill in the art would appreciate how this can be accomplished in modern computer systems.

If the procedure involves interaction with an application of which the assistant is a part, then the assistant can detect user actions and their results by registering appropriate application-levels callback functions that are executed in correspondence of specific events (such as, key presses, menu selections, window creations, etc.).

If the procedure involves interactions with multiple applications (e.g., word processing applications, spreadsheet applications, etc.) and with the operating system, then the assistant can detect user actions and their results by registering appropriate hooks with the operating system (“hooks” are system-wide callback functions that operate beyond the scope of individual applications) and by observing the content of the application windows using a variety of methods, which include, for example, issuing operating system calls, screen-scraping, etc.

In Step 102 of FIG. 1, the assistant can match the user actions to the model of the procedure to identify what part of the procedure the user is currently performing. The result of the matching is an alignment of the actions performed by the user to the steps in the procedure model.

It is noted that the exemplary assistant can have a model of the procedure being performed. That is, the assistant can know the goal of the procedure being performed. An exemplary aspect of the invention is to provide a system or method which is capable of determining, or interpreting, what the user is doing.

In Step 103, the assistant is capable of retaking the initiative when the user relinquishes the initiative. Thus, the assistant can continue the operations of the procedure.

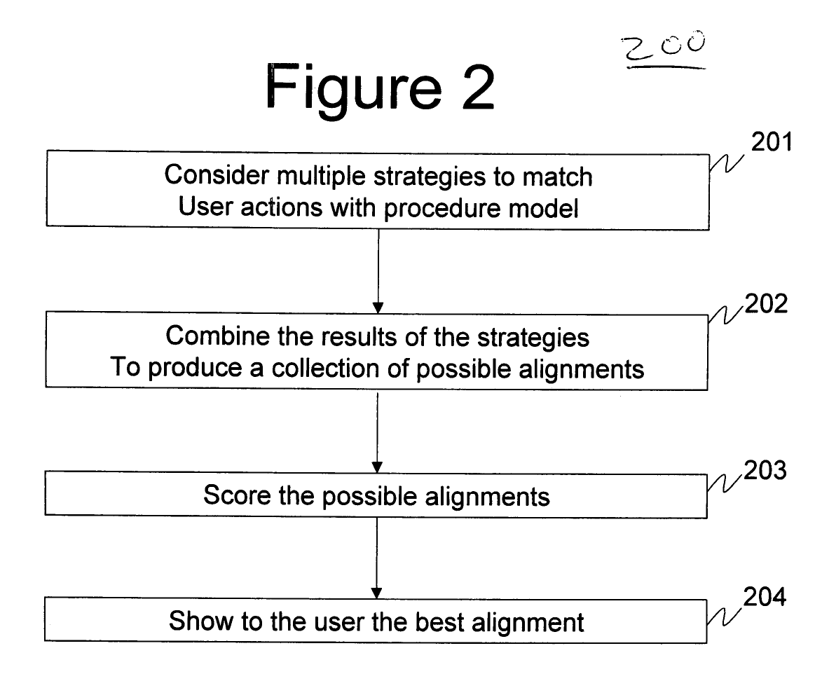

Turning now to FIG. 2, a preferred aspect of Step 102 of FIG. 1 is exemplarily illustrated.

As illustrated in Step 201 of FIG. 2, an exemplary aspect of the assistant can simultaneously consider a multiplicity of strategies to match the user actions with the procedure model. Each strategy can be capable of producing one or more possible alignments, and further, can produce a score denoting the confidence of the alignment.

In Step 202, the possible alignments produced by the strategies can be combined to produce an overall collection of possible alignments.

In Step 203, the possible alignments produced by Step 202 can be scored. For example, the system and method can include a means for assigning a plurality of scores to a plurality of possible alignments produced by Step 202.

A final score of an alignment can be used to indicate the overall confidence of the assistant that the alignment is correct.

As exemplarily illustrated in Step 204, the assistant can show the user the best alignment produced by Step 203. In a preferred exemplary aspect, the assistant can show the user the best alignment by highlighting the procedure step aligned to the last user action in the procedure model, which is graphically displayed to the user.

One of ordinary skill in the art would appreciate how the assistant could, within the spirit and scope of the present invention, display multiple alignments produced by Step 203. An exemplary aspect of the invention can display multiple alignments by highlighting them in different colors on the procedure model, wherein the colors are associated with the scores, or by allowing the user to cycle to the produced alignment by displaying them one at a time.

In a preferred embodiment, step 201 includes considering separately different individual activities that the user might be performing, such as the five activities listed above, and matching the user actions with the model of the procedure under the corresponding assumption.

For example, under the assumption that the user is performing irrelevant actions, the algorithm performing the matching preferably could discard the observed user actions until the user performs the next action that pertains to the procedure. On the other hand, under the assumption that the user jumped to a different part of the procedure, the algorithm performing the matching preferably could compare the user actions with each step of the procedure to identify similarities.

For example, an exemplary aspect of the invention can display the procedure model to the user and indicate where (e.g., what part, step, etc.) in the procedure model that the assistant believes the user is acting. An exemplary aspect of the invention can display multiple alignments by highlighting them in different colors on the procedure model, wherein the colors are associated with the scores, or by allowing the user to cycle to the produced alignment by displaying them one at a time. That is, the exemplary aspect of the assistant could display where (i.e., what part of or what step) in the procedure the assistant has determined the user to be, based on the scores using, for example: red (80%), green (15%), and blue (5%) to illustrate the assistant's certainty.

As described above, the exemplary aspects of the present invention are capable combining multiple alignments and scoring the multiple alignments for the mixed initiative (e.g., see FIG. 2, steps 202 and 203).

It is noted that the exemplary aspects of the invention also can display the possible alignments based on the preferred procedural model, quality of the results, etc.

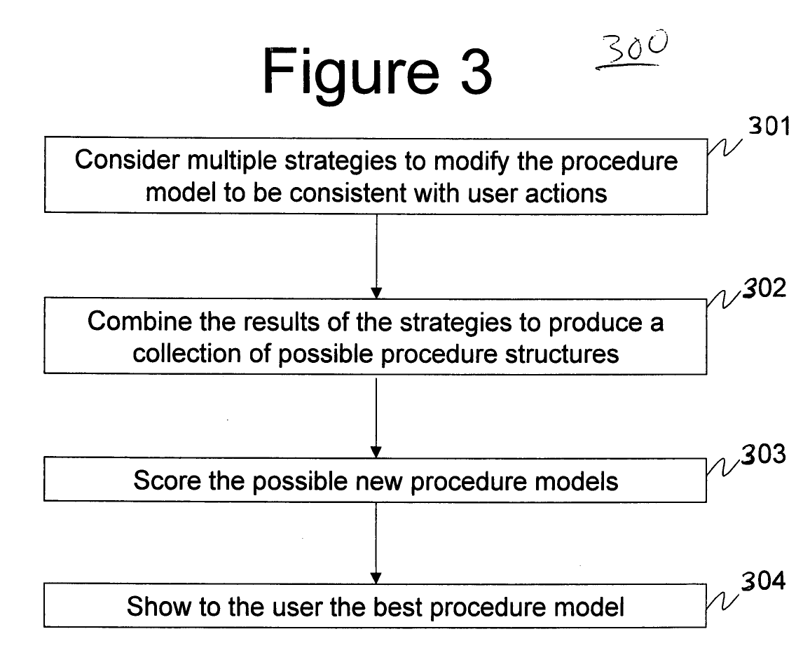

In another exemplary aspect of the invention, as illustrated in FIG. 3, instead of considering strategies to align the user actions to the procedure model, Step 102 can exemplarily be performed by considering multiple modifications of the procedure structure to be consistent with user actions and the reactions of the applications.

Co-pending patent application (Ser. No. ______, entitled “ ” and filed on ______ (Docket No. YOR9-2003-0056) teaches a way of constructing and modifying a procedure model using observations including user actions. Co-pending patent application (Ser. No. ______, entitled “ ” and filed on ______ (Docket No. YOR9-2004-0289) teaches a different way of constructing and modifying a procedure model using observations including user actions.

Step 301 considers a plurality of ways, such as the ones described in the above mentioned patent applications, to modify the procedure model to be consistent with the user actions. Step 302 combines the results of Step 301 in a fashion similar to Step 202 of FIG. 2.

In a preferred exemplary aspect of the invention, Step 202 includes pairwise comparing the alignments produced by the strategies, identifying identical alignments (Applicant notes that different strategies can produce identical alignments), grouping identical alignments into a group, and for each group of identical alignments retaining only one alignment, which can exemplarily be identified as the “representative”alignment of the group.

In a preferred exemplary aspect of the invention, Step 203 can be performed as follows. Each alignment produced by Step 202 represents a group of one or more identical alignments, where each alignment in a specific group is produced by a different strategy. If the strategies that produce alignments also produce scores (e.g., provide an indication of how well the alignment describes the observed sequence of user actions and system responses in light of the existing model), then Step 203 can associate with the representative of the group the sum of the scores of the alignments in the group. If the strategies that produce alignments do not produce scores, then Step 203 can associate with the representative of the group the number of elements in the group.

In another exemplary aspect of the invention, different strategies to produce alignments can include different weights. Generally speaking, these weights describe the a-priori degree of belief of the user in the suggestions produced by the strategies. Hence, a strategy with a low weight must be substantially more “confident” in its alignment than a strategy with high weight before the user is willing to accept its decision over the decision of the strategy with high weight. Then, if the strategies produce scores, Step 203 can associate with a representative of a group a score equal to the weighted sum of the scores of the alignments in the group, where the weights are the weights of the corresponding strategies. If the strategies do not produce scores, then Step 203 can associate with a representative a score equal to the sum of the weights of the strategies. One of ordinary skill in the art would appreciate how the weights could be built into the method and therefore be fixed, or could be selectable by the user, for example, using a “preferences” dialog.

In the field of pattern recognition, there has been recent interest into methods to combine different classifiers or “experts” (see, for example, Friedman and Popescu, “Predictive Learning Via Ensembles”, or, R. Duda, P. E. Hart, D. G. Stork, Pattern Classification, Wiley, 2000). One of ordinary skill in the art would appreciate how Steps 202 and 203 could be performed in combination by appropriately adapting the techniques described in the mentioned references.

Turning again to FIG. 3, instead of considering strategies to align the user actions to the procedure model, Step 102 can exemplarily be performed by considering multiple modifications of the procedure structure to be consistent with user actions and the reactions of the applications, as illustrated in FIG. 3.

For example, in Step 301, the assistant can consider multiple strategies to modify the procedure model to be consistent with the user's actions. In other words, the assistant can be capable of augmenting the procedural model.

In Step 302, the assistant can combine the results of the strategies to produce a collection of possible procedure structures. In Step 303, the assistant can score the possible new procedure models.

In Step 304, the assistant can display to the user the best procedure model.

In another exemplary aspect of the invention, Step 304 can display a plurality of possible procedural models based on the preferred procedural model, quality of the results, etc.

For example, if Strategy A is determined to require a larger modification of the procedure than Strategy B, then Strategy B may be scored higher than Strategy A. In other words, the strategy that involves the least disruption to the procedural model can be preferred, or scored higher, etc.

In the above exemplary aspect of the invention, an evolving interpretation of the procedure model also could be displayed to the user.

Another exemplary aspect of the present invention is learning procedural knowledge from demonstrations. For example, the system (e.g., assistant) can observe a user (or users) performing a procedure and combine the observation (or observations) into a model of the procedure. The model can be executable in cooperation with the user (e.g., the user can take the initiative away from the assistant or system).

For example, according to the exemplary aspects of the present invention, a user can perform an action other than the action indicated by the system. The system can observe the user's action and its results, match the action with a part of or step in the model, and propose a new action (or plurality of actions) to the user based on the determined match. The user can then accept the system's proposed action, or continue to perform actions other than the action indicated by the system.

According to the exemplary aspects of the present invention, the system can have a finite-state description of the procedure. The exemplary system can be capable of proposing actions, executing actions as instructed by the user, observing executed actions, and observing changes to the user interface.

When the system observes an action, the system can be capable of matching the action with a predicted action. If a match occurs, the system can select the next action. Otherwise, if a match does not occur, then the system can attempt to determine or figure out what is happening in the procedure, or where in the procedure (e.g., what part of, or step in, the procedure) the user is acting, and/or make an informed suggestion (or proposed action) to the user.

Among other things, the exemplary aspects of the invention are capable of detecting off-track mixed initiatives, constructing multiple realignment hypotheses, and performing realignment.

In a preferred exemplary aspect of the invention, the procedural model can include a finite-state model of the procedure. The model also can exemplarily be a probabilistic model or an un-probabilistic model. For example, the model exemplarily can be a grammar-based model, a machine language learning model, a machine language learning graphical model, a hierarchical model (i.e., a decision tree model), etc.

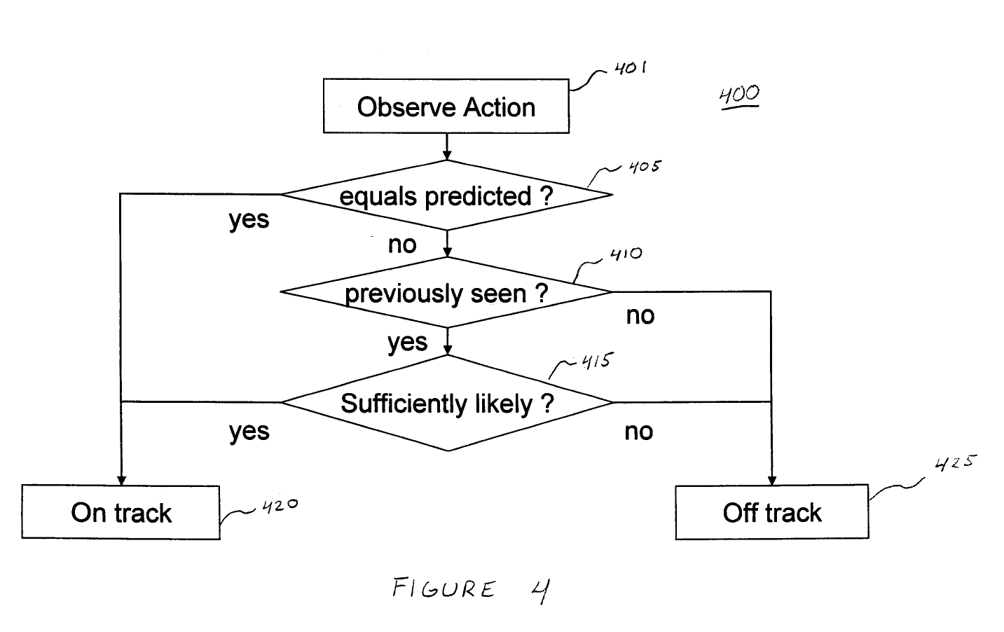

Turning now to FIGS. 4-7, the exemplary steps of observing or detecting whether the user's actions are on-track or off-track, constructing and updating the hypothesis set are illustrated, according to the exemplary aspects of the invention.

As illustrated in the method 400 of FIG. 4, the steps of observing the user's action (e.g., Step 101 in FIG. 1) and/or detecting whether the user's actions are on-track or off-track can exemplarily include Step 401 of observing the user's (or users') actions. In Step 405, the system (e.g., assistant) determines whether the observed user action is the same as (or substantially equal to) a predicted action (e.g., in the procedural model). If so, the system determines that the user's action is on-track (e.g., 420).

If not, then in Step 410, the system determined whether the user's action has been previously seen by the system. If not, then the system determines that the user's action is off-track (e.g., 425).

However, if the user's action has been previously seen, then the system determines, in Step 415, whether the user's action is sufficiently likely to be part of (e.g., corresponds to) one of the steps of the procedural model. If so, then the system can determine that the user's action is on-track. If not, then the system can determine that the user's action is off-track.

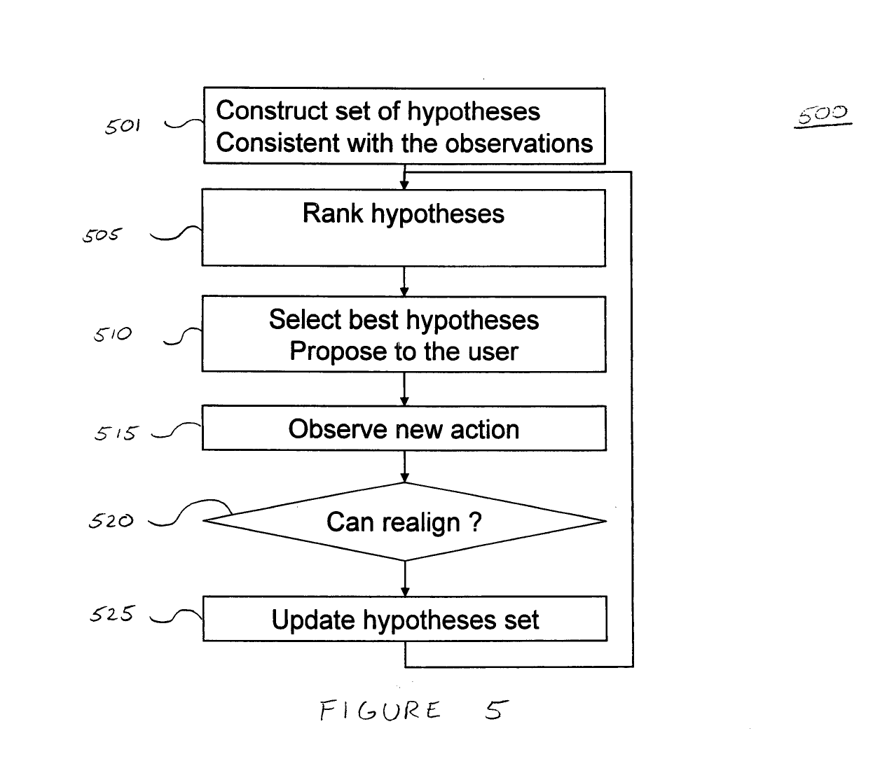

Turning to FIG. 5, the exemplary method 500 of constructing the set of hypotheses will be explained.

As exemplarily illustrated in FIG. 5, the system constructs (e.g., Step 501) a set of hypotheses consistent with the observations (e.g., Step 101 in FIG. 1, Step 401 in FIG. 4). Next, the system ranks (e.g., Step 505) the hypotheses (e.g., by posterior probability, preferably by means of heuristics, by combining heuristics and posterior probabilities, etc.). The system then selects (e.g., Step 510) the best hypotheses and proposed the same to the user. The system again observes (e.g., Step 515) the user's new or next action and determines whether the new action can be realigned (e.g., Step 520) with the procedural model and updates (e.g., Step 525) the hypotheses set.

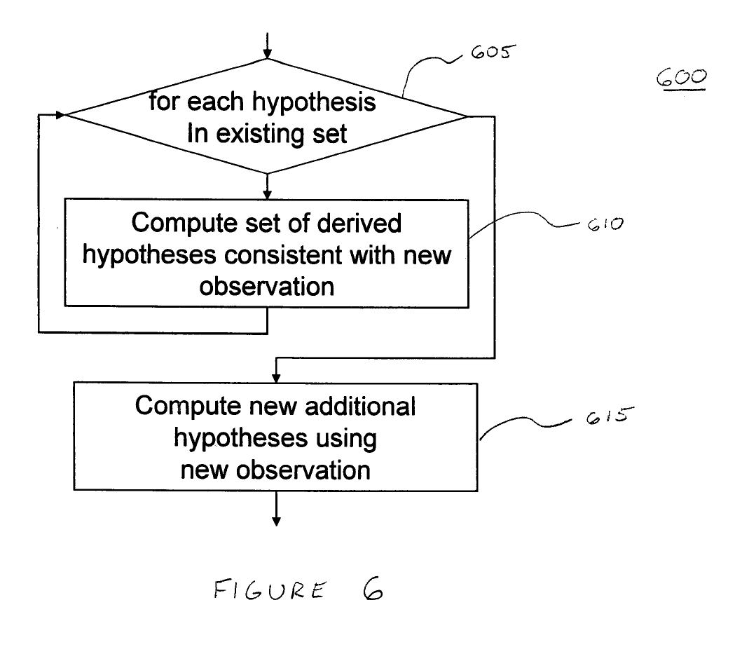

Turning to FIG. 6, the exemplary method 600 of updating the hypotheses set (e.g., Step 525 in FIG. 5) will be explained.

In FIG. 6, for each hypotheses in the existing set of hypotheses (e.g., Step 605), the system preferably computes (e.g., Step 610) a set of derived hypotheses consistent with the new observation (e.g., Step 515 in FIG. 5) and computes (e.g., Step 615) new additional hypotheses using the new observation.

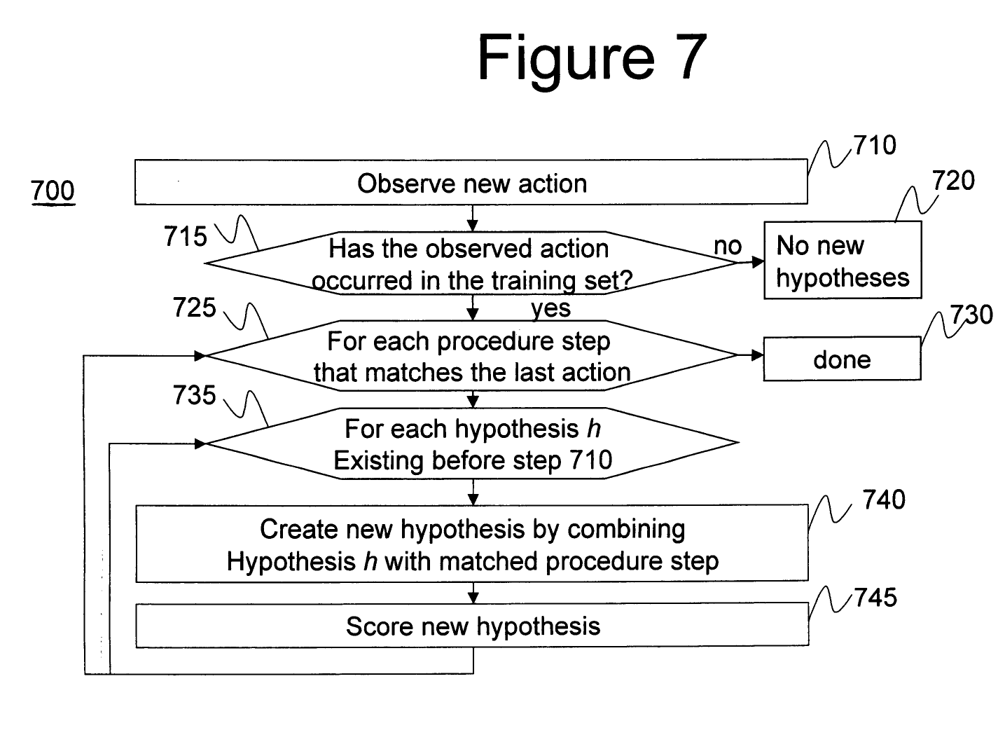

Turning to FIG. 7, the method 700 of computing the set of hypotheses (e.g., Step 501 in FIG. 5) will be explained. When a new user action is observed (e.g., Step 710), it is first compared with the actions previously observed when collecting user actions to construct the model of the procedure (e.g., this collection preferably is identified as a “training set”)(e.g. Step 715). If the observed user action (e.g., which preferably is identified as a “current action”) has not been previously observed, no novel (e.g., new) hypothesis is constructed (e.g., Step 720).

An exemplary interpretation of the illustrative Step 720 is that, when presented a previously unknown action, the exemplary method preferably retains each existing hypothesis, and increments each hypothesis with the information that the current action has never been observed in the data used to construct the procedure model. If the current action has been observed, namely, if it belongs to the data used to construct the procedure model, then the steps in the procedure model that match the current action preferably are identified and iterated upon (e.g., Step 725).

For example, consider the case in which the user clicks a button labeled “OK” in a specific dialog. Then Step 725 preferably would analyze the procedure model and retrieve all the steps corresponding to the action of clicking the specific “OK” button. Since the action has been observed (namely, the action is in the training set), there would be at least one retrieved step in the procedure. However, in general, there can be multiple places within the procedure models where the action is to click the “OK” button. Therefore, generally, more than one matching procedure step can be identified by Step 725. Step 725 also preferably ensures that Steps 735 to 745 are executed on each of the retrieved procedure steps. When Steps 735 to 745 have been executed on all the retrieved procedure step, Step 725 preferably concludes method 700 (e.g., in Step 730).

Turning to exemplary Steps 735 to 745, Step 735 preferably iterates on each hypothesis that existed before Step 710, for example, on every hypothesis created by exemplary method 700 using the actions observed before the new action observed in Step 710.

Step 740 preferably combines the hypothesis selected by Step 735 with the matched step selected in Step 725, to create a new hypothesis. The new hypothesis preferably consists of the hypothesis selected by Step 710 for all of the actions observed before the current action, incremented by appending to it a jump to the procedure step selected by Step 725.

Step 745 preferably scores the new hypothesis. The collection of scored hypotheses produced by Step 745 for a new current action preferably become the set of hypotheses on which Step 735 iterates the next time that a user action is observed.

The ordinarily skilled artisan would understand that the exemplary aspects of the present invention can be practiced with modification within the spirit and scope of the appended claims. While the illustrative, non-limiting aspects of the invention are exemplarily described above with reference to a user interacting with one or more applications in a computer system, the exemplary aspects of the present invention also can be practiced with respect to robotics (e.g., as mentioned above, a control program interacting with a robotic mechanical system, etc.), an autonomic agent interacting with a network of computer systems, workflow management systems, intelligent devices (e.g., which take the initiative and, for example, apply the brakes on an automobile, turn on a turn signal on an automobile, etc.), any application where a user is in the loop, and/or any application where it may be desirable to provide the user with the option of taking the initiative at any time (or at certain, predetermined times) or where it may be desirable to provide the user with the option of allowing the system to take the initiative at any time (or at certain, predetermined times), etc.

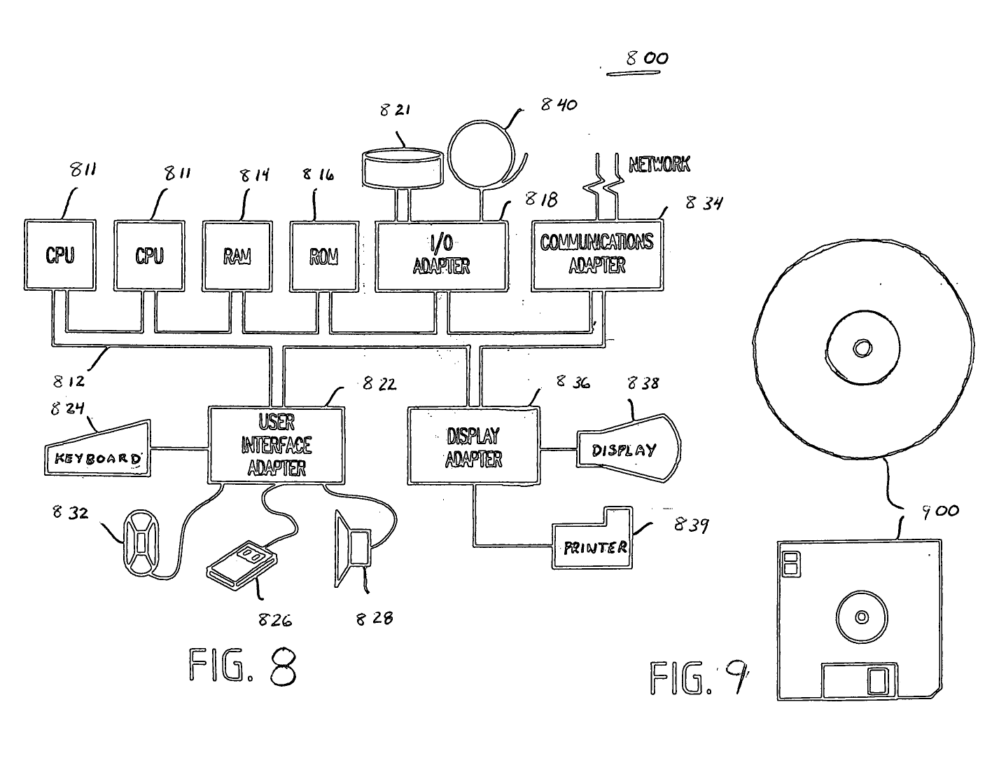

FIG. 8 illustrates a typical hardware configuration of an information handling/computer system for use with the invention and which preferably has at least one processor or central processing unit (CPU) 811.

The CPUs 811 are interconnected via a system bus 812 to a random access memory (RAM) 814, read-only memory (ROM) 816, input/output (I/O) adapter 818 (for connecting peripheral devices such as disk units 821 and tape drives 840 to the bus 812), user interface adapter 822 (for connecting a keyboard 824, mouse 826, speaker 828, microphone 832, and/or other user interface device to the bus 812), a communication adapter 834 for connecting an information handling system to a data processing network, the Internet, an Intranet, a personal area network (PAN), etc., and a display adapter 836 for connecting the bus 812 to a display device 838 and/or printer.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 811, as represented by the fast-access storage for example. Alternatively, the instructions may be contained in another signal-bearing media, such as a magnetic data storage or CD-ROM diskette 900 (FIG. 9), directly or indirectly accessible by the CPU 811.

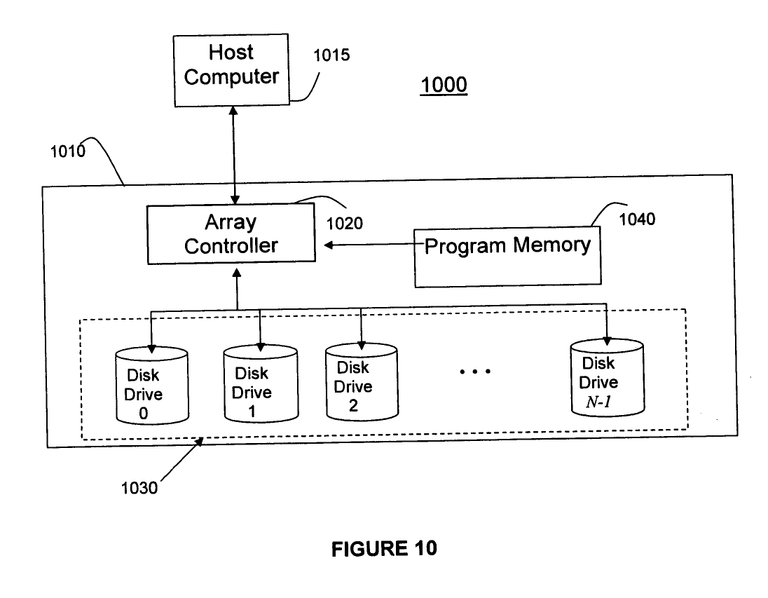

Whether contained in the diskette 900, the computer/CPU 811, or elsewhere, the instructions may be stored on a variety of machine-readable data storage media, such as DASD storage (e.g., a conventional “hard drive” or a RAID array (e.g., 1000 in FIG. 10)), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. The ordinarily skilled artisan would understand that a RAID array (e.g., 1000 in FIG. 10) could include a host computer 1015 connected to an array controller 1020 of a system 1010. The host computer 1015 could store data on the array controller 1020. The array controller could use a program or logic extracted from the program memory 1040 to determine redundancy values for the data according to the erasure code of the system 1010, and store the data and parity values in the disk drives 1030. If sector losses are detected by the array controller 1020 when accessing one or more of the disk drives 1030, then the array controller could call on additional program instructions from the program memory 1040 to determine recovery formulas using a combination of direct methods and sequential methods.

In an illustrative embodiment of the invention, the machine-readable instructions may comprise software object code, compiled from a language such as “C”, etc.

Additionally, in yet another aspect of the present invention, it should be readily recognized by one of ordinary skill in the art, after taking the present discussion as a whole, that the present invention can serve as a basis for a number of business or service activities. All of the potential service-related activities are intended as being covered by the present invention.

While the invention has been described in terms of several exemplary embodiments, those skilled in the art will recognize that the invention can be practiced with modification within the spirit and scope of the appended claims.

Further, it is noted that, Applicant's intent is to encompass equivalents of all claim elements, even if amended later during prosecution.

What is claimed is:

1. A method of executing mixed-initiative procedures, comprising:
allowing at least one of a user and a computer system to take initiative of the procedure from the other of said user and said computer system at any point of the procedure.

2. The method according to claim 1, wherein said mixed-initiative procedure includes a computer-based procedure in which said user and said computer system cooperate during the execution to allow each other to take the initiative of the procedure at any point of the procedure.

3. A method of executing mixed-initiative procedures, comprising:
allowing at least one of a user and a program to take initiative of the procedure from the other of said user and said program at any point of the procedure.

4. The method according to claim 3, wherein the user and the program cooperate, and
wherein said program includes a model of said computer-based procedure.

5. The method according to claim 4, wherein said method comprises:
allowing said user to take initiative from said program;
observing user actions and responses of applications used to perform said procedure;
aligning said observed user actions and application responses to the model of the procedure; and
allowing said user to relinquish the initiative to said program.

6. The method according to claim 5, wherein said aligning said observed user actions and application responses to said model of the procedure, further comprises:
using multiple strategies to align said observed user actions and application responses to said model of the procedure;
combining the alignments produced by said multiple strategies to produce a collection of alignments;
scoring said alignments; and
displaying to the user at least one alignment of said scored alignments which includes a highest score of said scored alignments.

7. The method according to claim 5, wherein said aligning said observed user actions and application responses to said model of the procedure, further comprises:
using multiple strategies to modify said model of the procedure to be substantially consistent with said user actions and application responses;
combining the results of said multiple strategies to produce a collection of modifications of said procedure;
scoring said modifications in said collection of modifications; and
displaying to the user at least one modification of said scored modification which includes a highest score of said scored modifications.

8. The method according to claim 6, wherein allowing said user to relinquish the initiative to said program, comprises:
continuing cooperation between said user and said program from a procedure step which follows a step aligned with the observed action in said alignment including the highest score.

9. The method according to claim 7, wherein allowing said user to relinquish the initiative to said program, comprises:
continuing cooperation between said user and said program from a procedure step which follows a step modified based on the observed action in said modification including the highest score.

10. The method according to claim 6, wherein said displaying comprises:
displaying to the user a plurality of alignments of said scored alignments,
wherein said plurality of alignments are arranged based on at least one of a predetermined preferred procedural model, a quality of results, an order of said scored alignments, and a certainty of said alignments.

11. The method according to claim 7, wherein said displaying comprises:
displaying to the user a plurality of modifications of said scored modifications,
wherein said plurality of modifications are arranged based on at least one of a predetermined preferred procedural model, a quality of results, an order of said scored modifications, and a certainty of said modifications.

12. The method according to claim 1, further comprising:
allowing mixed-initiative procedures wherein the user can perform at least one of previously unseen actions and uncoded actions which are unrelated to the procedure being performed.

13. The method according to claim 1, further comprising:
allowing mixed-initiative procedures wherein the user can perform at least one of previously unseen actions and uncoded actions which are related to the procedure being performed and correspond to at least one of uncoded paths and previously unseen paths through the procedure.

14. The method according to claim 1, further comprising:
identifying at least one of previously unseen actions and uncoded actions performed by a user; and
flagging substantially unlikely actions performed by the user,
wherein the user can perform said previously unseen actions and uncoded actions that at least one of are unrelated to the procedure being performed, and are related to the procedure being performed and correspond to at least one of uncoded paths and previously unseen paths through the procedure.

15. The method according to claim 1, further comprising:
detecting off-track actions performs by said user in said mixed-initiative procedure;
constructing at least one realignment possibility based on said user's off-track action and a model of said mixed-initiative procedure;
performing realignment based on at least one of said user's selection, a highest score of an alignment of said at least one realignment possibility.

16. The method according to claim 1, wherein said allowing comprises:
observing an action by said user;
comparing said action with previously observed actions and determining whether said action substantially corresponds to at least one of said previously observed actions;
wherein said previously observed actions include a collection of user actions used to construct a model of the procedure;
wherein, if said action is determined to substantially correspond to said at least one of said previously observed actions, the method includes:
constructing a hypothesis for each of said at least one of said previously observed actions in the procedure model which is determined to substantially correspond to said action;
scoring said hypothesis for each of said previously observed actions in the procedure model which are determined to substantially correspond to said action;
wherein, if said action is determined to correspond to an unobserved action, the method includes:
retaining at least one previously constructed hypothesis.

17. A method of deploying computing infrastructure in which computer-readable code is integrated into a computing system, and combines with said computing system to perform the method according to claim 1.

18. A signal-bearing medium tangibly embodying a program of machine-readable instructions executable by a digital processing apparatus to perform the method according to claim 1.

19. A system for executing mixed-initiative procedures to allow at least one of a user and a computer system to take initiative of the procedure from the other of said user and said computer system at any point of the procedure, the system comprising:
a detector that identifies at least one of previously unseen actions and uncoded actions performed by a user in the procedure.

20. The system according to claim 19, wherein the user can perform at least one of said previously unseen and said uncoded actions that at least one of are unrelated to the procedure being performed, and are related to the procedure being performed and correspond to at least one of uncoded paths and previously unseen paths through the procedure.
